(19) United States
(12) Patent Application Publication
(10) Pub. No.: US 2024/0176612 A1
(43) Pub. Date: May 30, 2024

(54) VEHICLE, SOFTWARE UPDATE METHOD, AND NON-TRANSITORY STORAGE MEDIUM

(71) Applicant: TOYOTA JIDOSHA KABUSHIKI KAISHA, Toyota-shi (JP)

(72) Inventors: Tomoyasu ISHIKAWA, Nagoya-shi (JP); Hiroshi INOUE, Nagoya-shi (JP); Shunsuke TANIMORI, Arlington, VA (US); Nana KIKUIRE, Toyota-shi (JP)

(73) Assignee: TOYOTA JIDOSHA KABUSHIKI KAISHA, Toyota-shi (JP)

(21) Appl. No.: 18/469,096

(22) Filed: Sep. 18, 2023

(30) Foreign Application Priority Data
Nov. 28, 2022 (JP) 2022-189045

(51) Int. Cl. G06F 8/65

(52) U.S. Cl. CPC G06F 8/65

(57) ABSTRACT

A vehicle including an ECU configured to execute software update by using software distributed from a server includes a start switch configured to stop a control system of the vehicle when the start switch is turned OFF, and a control device. The control device is configured to request acceptance to execute activation after the start switch is turned OFF. The control device is configured to, when the ECU is a single-bank computer: download the software; and then instruct the ECU to install the downloaded software in the ECU and activate the installed software after a user accepts to execute the activation. The control device is configured to, when the ECU is a dual-bank computer, instruct the ECU to activate the installed software after the user accepts to execute the activation.

### CROSS-REFERENCE TO RELATED APPLICATION

This application claims priority to Japanese Patent Application No. 2022-189045 filed on Nov. 28, 2022, incorporated herein by reference in its entirety.

### BACKGROUND

### 1. Technical Field

The present disclosure relates to a vehicle, a software update method, and a non-transitory storage medium.

### 2. Description of Related Art

Japanese Unexamined Patent Application Publication No. 2017-149323 (JP 2017-149323 A) discloses a technology for updating software of an electronic control unit (ECU) mounted on a vehicle by an Over The Air (OTA) technology.

### SUMMARY

A vehicle can download new software for an in-vehicle ECU from an OTA center by wirelessly communicating with the OTA center. In the vehicle, a target ECU (ECU whose software is to be updated) sequentially executes installation and activation of the new software. Thus, software update can be executed.

A typical in-vehicle ECU includes one or more computers (microcomputers). Typical computers in the in-vehicle ECU are roughly classified into a dual-bank computer and a single-bank computer.

In the dual-bank computer, two banks are formed by two memory areas. The dual-bank computer has an area where software (program) that is being executed is stored and an area where update (new) software is stored. The update software can be installed during execution of current software.

In the single-bank computer, one bank is formed by one memory area. In the single-bank computer, the area where current software is stored and the area where update software is stored are the same. Therefore, it is difficult to install the update software during execution of the current software.

When the in-vehicle ECU includes both the single-bank computer and the dual-bank computer, installation for the in-vehicle ECU (target ECU) may be started while the single-bank in-vehicle ECU stops execution of software (program), for example, while a vehicle system is stopped. In this case, the software update timing may be limited or deferred (postponed).

With the present disclosure, software update can be executed appropriately and promptly even when an in-vehicle ECU includes both a single-bank computer and a dual-bank computer.

In a first aspect of the present disclosure, a vehicle including an electronic control unit configured to execute software update by using software distributed from a server includes a start switch configured to start a control system of the vehicle when the start switch is turned ON, and to stop the control system of the vehicle when the start switch is turned OFF, and a control device. The control device is configured to control a process for the software update. The control device is configured to request acceptance to execute activation after the start switch is turned OFF. The control device is configured to, when the electronic control unit is a single-bank computer, download the software distributed from the server, and then instruct the electronic control unit to install the downloaded software in the electronic control unit and activate the installed software after a user accepts to execute the activation. The control device is configured to, when the electronic control unit is a dual-bank computer, download the software distributed from the server, instruct the electronic control unit to install the downloaded software in the electronic control unit, and then instruct the electronic control unit to activate the installed software after the user accepts to execute the activation.

With this configuration, when the electronic control unit includes both the single-bank computer and the dual-bank computer, the control device executes, for the electronic control unit including the single-bank computer, download of the software distributed from the server, and then installation of the downloaded software in the electronic control unit and activation of the installed software after the user accepts to execute the activation. For the electronic control unit including the dual-bank computer, the control device executes download of the software distributed from the server and installation of the downloaded software in the electronic control unit, and then activation of the installed software after the user accepts to execute the activation.

When the start switch is turned OFF, the control system of the vehicle can be stopped. Thus, the software can be installed in the single-bank computer. Therefore, the electronic control unit including the single-bank computer executes installation and activation when the acceptance to execute the activation is made after the start switch is turned OFF. The electronic control unit including the dual-bank computer installs the software before the start switch is turned OFF, and activates the software when the start switch is turned OFF and the acceptance to execute the activation is made. Thus, the software update can be executed appropriately and promptly for each ECU.

It is desirable to obtain acceptance from the vehicle user when the software of the electronic control unit is updated. When the electronic control unit includes both the single-bank computer and the dual-bank computer, acceptance of “installation and activation” for the single-bank electronic control unit and acceptance of “activation” for the dual-bank electronic control unit may be requested after the start switch is turned OFF. In this case, the user is requested to make two types of acceptance, thereby causing complication.

With this configuration, the control device requests acceptance to execute the activation when the start switch is turned OFF. In a case where the electronic control unit is the single-bank computer when the user accepts to execute the activation, the software is installed and activated. In a case where the electronic control unit is the dual-bank computer when the user accepts to execute the activation, the installed software is activated. Therefore, in the single-bank electronic control unit, the installation and activation are executed by accepting “activation”. Thus, only one type of acceptance can be made after the start switch is turned OFF, thereby reducing the complication.

In the vehicle according to the first aspect of the present disclosure, the electronic control unit may be an electronic control unit configured to execute traveling control on the vehicle. When the start switch is turned OFF, the execution of the software (program) by the electronic control unit is stopped, and the control system of the vehicle can be stopped.

In a second aspect of the present disclosure, a software update method for executing software update for an in-vehicle electronic control unit by using software distributed from a server includes the following: requesting acceptance to execute activation when a start switch configured to start a control system of a vehicle when the start switch is turned ON and to stop the control system of the vehicle when the start switch is turned OFF is turned OFF; when the in-vehicle electronic control unit is a single-bank computer, downloading the software distributed from the server, and then instructing the in-vehicle electronic control unit to install the downloaded software in the in-vehicle electronic control unit and activate the installed software after a user accepts to execute the activation; and when the in-vehicle electronic control unit is a dual-bank computer, downloading the software distributed from the server, instructing the in-vehicle electronic control unit to install the downloaded software in the in-vehicle electronic control unit, and then instructing the in-vehicle electronic control unit to activate the installed software after the user accepts to execute the activation.

With this method, the electronic control unit including the single-bank computer executes installation and activation when the start switch is turned OFF and the acceptance to execute the activation is made. The electronic control unit including the dual-bank computer installs the software before the start switch is turned OFF, and activates the software when the start switch is turned OFF and the acceptance to execute the activation is made. Thus, the software update can be executed appropriately and promptly for each ECU.

According to this method, the acceptance to execute the activation is requested when the start switch is turned OFF. With the user's acceptance, the single-bank ECU executes the installation and activation. Thus, only one type of acceptance can be made after the start switch is turned OFF, thereby reducing the complication.

A non-transitory storage medium according to a third aspect of the present disclosure is configured to store a program that causes a control device to execute the software update method.

According to a fourth aspect of the present disclosure, a vehicle including an electronic control unit configured to execute software update from pre-update software to post-update software by using data distributed from a server includes a switch configured to stop a control system of the vehicle when the switch is turned OFF, and a control device. The control device is configured to control a process for the software update. The control device is configured to request acceptance to execute activation after the switch is turned OFF. The control device is configured to determine whether the electronic control unit is a single-bank computer or a dual-bank computer. The control device is configured to, when the electronic control unit is the single-bank computer and the control device receives the acceptance to execute the activation, instruct the electronic control unit to install the post-update software in the electronic control unit and activate the post-update software. The control device is configured to, when the electronic control unit is the dual-bank computer and the control device receives the acceptance to execute the activation, instruct the electronic control unit to activate the post-update software.

Also in the vehicle of the fourth aspect of the present disclosure, only one type of acceptance can be made after the switch is turned OFF, thereby reducing the complication.

With the present disclosure, software update can be executed appropriately and promptly even when the in-vehicle ECU includes both the single-bank computer and the dual-bank computer.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows the schematic configuration of a software update system including vehicles according to an embodiment;

FIG. 2 illustrates an overview of a software update method using an OTA technology;

FIG. 3 schematically shows a part of a sequence that is executed in the software update system according to the embodiment;

FIG. 4 shows an example of a display screen displayed on a touch panel display of a human-machine interface (HMI) device;

FIG. 5 shows an example of the display screen displayed on the touch panel display of the HMI device; and

FIG. 6 shows an example of the display screen displayed on the touch panel display of the HMI device.

### DETAILED DESCRIPTION OF EMBODIMENTS

An embodiment of the present disclosure will be described in detail with reference to the drawings. The same or corresponding parts are denoted by the same signs throughout the drawings, and description thereof will not be repeated.

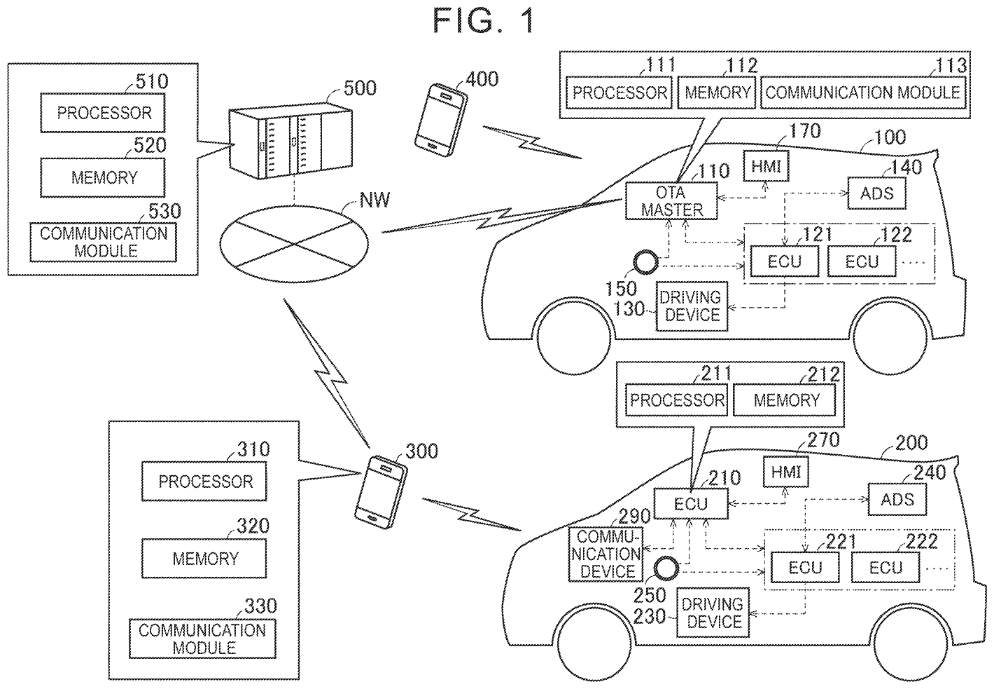

FIG. 1 shows the schematic configuration of a software update system including vehicles according to the present embodiment. The software update system includes a vehicle 100, a vehicle 200, user terminals 300, 400, an OTA center 500, and a network NW. “OTA” is an abbreviation for “Over The Air”.

Each of the vehicles 100, 200 is, for example, a battery electric vehicle (BEV) without an internal combustion engine. The vehicle 100 has an OTA access function (function to wirelessly communicate directly with the OTA center 500). The vehicle 200 does not have the OTA access function. That is, the vehicle 100 can wirelessly communicate directly with the OTA center 500. On the other hand, the vehicle 200 cannot communicate with the OTA center 500 without intermediation of another communication device (i.e., a communication device different from that mounted on the vehicle 200 itself). The vehicle 200 wirelessly communicates with the OTA center 500 through the user terminal 300 (via the user terminal 300).

The user terminal 300 can be carried by a user. The user terminal 300 is a mobile terminal carried and operated by a user (vehicle manager) of the vehicle 200. In the present embodiment, a smartphone including a touch panel display (display unit) is adopted as the user terminal 300. The smartphone includes a built-in computer, and has a speaker function. However, the user terminal 300 is not limited to this, and any terminal that can be carried by the user of the vehicle 200 can be used as the user terminal 300. For example, a laptop computer, a tablet terminal, a portable gaming device, or a wearable device (such as a smartwatch, smart glasses, or smart gloves) can be adopted as the user terminal 300.

The user terminal 300 includes a processor 310, a memory 320, and a communication module 330. The processor 310 includes, for example, a central processing unit (CPU). The memory 320 includes a non-volatile memory such as a flash memory. The communication module 330 includes a communication interface (I/F) for wirelessly communicating directly with the OTA center 500. The communication module 330 also includes a communication I/F for wirelessly communicating directly with the vehicle 200. Thus, the vehicle 200 and the OTA center 500 can exchange data via the user terminal 300. For example, the user terminal 300 specifies an address of the OTA center 500 and accesses the communication network NW in response to a request from the vehicle 200. Thus, the vehicle 200 (ECU 210) and the OTA center 500 can exchange (communicate) data via the user terminal 300.

Application software (hereinafter referred to as “mobile app”) for using a service provided by the OTA center 500 is installed in the user terminal 300. Identification information of the user terminal 300 (terminal identifier (ID)) is registered in the OTA center 500 in association with identification information of the vehicle 200 (vehicle ID) through the mobile app. The user terminal 300 can exchange information with the OTA center 500 through the mobile app. The user terminal 300 also functions as an input device and a display device.

The OTA center 500 is a server that provides a vehicle software update service by the OTA technology. The OTA center 500 updates software of an in-vehicle ECU remotely from the center by way of a communication block. The OTA center 500 distributes software for the in-vehicle ECU. The term “ECU” means an electronic control unit.

The OTA center 500 includes a processor 510, a memory 520, and a communication module 530. The processor 510 includes, for example, a CPU. The memory 520 includes a non-volatile memory such as a flash memory. The communication module 530 is connected to the communication network NW by wire, and communicates with a plurality of vehicles (including the vehicle 100) and a plurality of mobile terminals (including the user terminal 300) via the communication network NW. The communication network NW is a wide area network formed by, for example, the Internet and wireless base stations. The communication network NW may include a cellular telephone network. The communication module 530 and the communication network NW may be wirelessly connected.

The vehicle 100 includes an OTA master 110 and a plurality of ECUs (including ECUs 121, 122). The vehicle 200 includes a plurality of ECUs (including ECUs 210, 221, 222). The OTA master 110 includes a built-in computer and functions as an in-vehicle diagnosis device. Each vehicle may include any number of ECUs. Each in-vehicle ECU includes a built-in computer that includes at least one processor and at least one memory. Each in-vehicle ECU may include a plurality of microcomputers in the form of, for example, a main microcomputer and a sub-microcomputer.

In the vehicle 100, the OTA master 110 and each ECU are connected to each other via a communication bus, and are configured to communicate with each other by wire. In the vehicle 200, the ECUs are connected to each other via a communication bus, and are configured to communicate with each other by wire. The method for communication between control devices in each vehicle is not particularly limited. The method for communication may be, for example, a controller area network (CAN) or Ethernet (registered trademark).

The OTA master 110 includes a processor 111, a memory 112, and a communication module 113. The processor 111 includes, for example, a CPU. The memory 112 includes a non-volatile memory such as a flash memory. The communication module 113 includes a communication interface (I/F) for wirelessly communicating directly with the OTA center 500. For example, wireless communication between the vehicle 100 (communication module 113) and the OTA center 500 is established by the communication module 113 accessing the communication network NW by specifying the address of the OTA center 500. The communication module 113 may include a telematics control unit (TCU) and/or a data communication module (DCM) that performs wireless communication.

In the vehicle 200, the ECU 210 includes a processor 211 and a memory 212. The processor 211 includes, for example, a CPU. The memory 212 includes a non-volatile memory such as a flash memory. The vehicle 200 further includes a communication device 290. The ECU 210 communicates with devices outside the vehicle through the communication device 290. The communication device 290 includes a communication interface (I/F) for wirelessly communicating directly with the user terminal 300. The communication device 290 and the user terminal 300 may perform short-range communication such as a wireless local area network (LAN), near field communication (NFC), or Bluetooth (registered trademark). The communication device 290 may communicate directly with the user terminal 300 that is present inside the vehicle 200 or in a range around the vehicle 200. Information may be exchanged with each other via the communication device 290 between the user terminal 300 inside or outside the vehicle and the ECU 210 while the vehicle 200 is stationary. Information may be exchanged with each other via the communication device 290 between the user terminal 300 inside the vehicle and the ECU 210 while the vehicle 200 is traveling. The ECU 210 can communicate with the OTA center 500 via the user terminal 300 by requesting the user terminal 300 to communicate with the OTA center 500 as described above.

In the vehicle 100, the OTA master 110 can communicate with the user terminal 400 via the communication module 113. The communication module 113 includes a communication interface (I/F) for wirelessly communicating directly with the user terminal 400. The communication module 113 and the user terminal 400 may perform short-range communication such as a wireless LAN, NFC, or Bluetooth (registered trademark). The user terminal 400 may be a smartphone including a touch panel display (display unit), and also functions as an input device and a display device. The vehicle 100 may include, instead of the OTA master 110, a communication device that communicates with the network NW or the user terminal 400.

As described above, each of the OTA master 110 of the vehicle 100 and the ECU 210 of the vehicle 200 is configured to communicate wirelessly with the OTA center 500. Each of the vehicles 100, 200 can communicate with the OTA center 500 both while the vehicle is stationary and while the vehicle is traveling. Each of the OTA master 110 and the ECU 210 manages in-vehicle information, receives a campaign, and manages a software update sequence. Hereinafter, the OTA master 110 and the ECU 210 will be referred to as “update masters” when not distinguished from each other. The OTA master 110 is the update master of the vehicle 100, and the ECU 210 is the update master of the vehicle 200.

The vehicles 100, 200 are autonomous vehicles configured to perform autonomous driving. The vehicles 100, 200 are configured to perform both manned travel and unmanned travel. Although the vehicles 100, 200 are configured to perform unmanned autonomous driving, the vehicles 100, 200 can also be manually driven by users (manned travel). The vehicles 100, 200 can also perform autonomous driving (e.g., auto cruise control) during manned travel. The level of autonomous driving may be fully autonomous driving (level 5), or may be conditional autonomous driving (e.g., level 4).

The vehicles 100, 200 include driving devices 130, 230 and autonomous driving systems (ADSs) 140, 240, respectively. In the vehicle 100, the ECU 121 controls the driving device 130. In the vehicle 200, the ECU 221 controls the driving device 230.

Each of the driving devices 130, 230 includes an accelerator device, a brake device, and a steering device. The accelerator device includes, for example, a motor generator (hereinafter referred to as “MG”) that rotates drive wheels of the vehicle, a power control unit (PCU) that drives the MG, and a battery that supplies electric power for driving the MG to the PCU.

Each of the ADSs 140, 240 includes a recognition sensor (e.g., at least one of a camera, a millimeter wave radar, and a lidar) that recognizes an external environment of the vehicle. Each of the ADSs 140, 240 executes a process related to autonomous driving based on information sequentially acquired by the recognition sensor. Each of the ADSs 140, 240 cooperates with the ECU 121, 221 to generate a travel plan (information indicating the future behavior of the vehicle) depending on the external environment of the vehicle. Each of the ADSs 140, 240 requests the ECU 121, 221 to control various actuators in the driving device 130, 230 to cause the vehicle 100, 200 to travel in accordance with the travel plan.

The vehicles 100, 200 include start switches 150, 250 and human-machine interface (HMI) devices 170, 270, respectively.

Each of the start switches 150, 250 is a switch for the user to start a vehicle system (control system for the vehicle 100, 200), and is installed in, for example, a vehicle cabin. In general, the start switch is referred to as “power switch” or “ignition switch”. The vehicle system (including the ECUs mounted on the vehicle) is switched between ON (activated) and OFF (deactivated) by the operation of the start switch 150, 250 by the user. By turning ON the start switch 150, 250, the vehicle system in the deactivated state is started and brought into the activated state (hereinafter also referred to as “IG-ON”). By turning OFF the start switch 150, 250 when the vehicle system is activated, the vehicle system is brought into the deactivated state (hereinafter also referred to as “IG-OFF”).

The operation to turn ON the start switch 150, 250 is an operation to switch the state of the vehicle from IG-OFF to IG-ON. When the user turns ON the start switch 150, 250, a startup request is input to each in-vehicle ECU. That is, each in-vehicle ECU receives the startup request from the user. The operation to turn OFF the start switch 150, 250 is an operation to switch the state of the vehicle from IG-ON to IG-OFF. When the user turns OFF the start switch 150, 250, a shutdown request is input to each in-vehicle ECU. That is, each in-vehicle ECU receives the shutdown request from the user. However, the operation to turn OFF the start switch 150, 250 is prohibited while the vehicle is traveling.

Each of the HMI devices 170, 270 includes an input device and a display device. Each of the HMI devices 170, 270 may include a touch panel display that functions as both an input device and a display device. Each of the HMI devices 170, 270 may include an input device and a display device of a car navigation system.

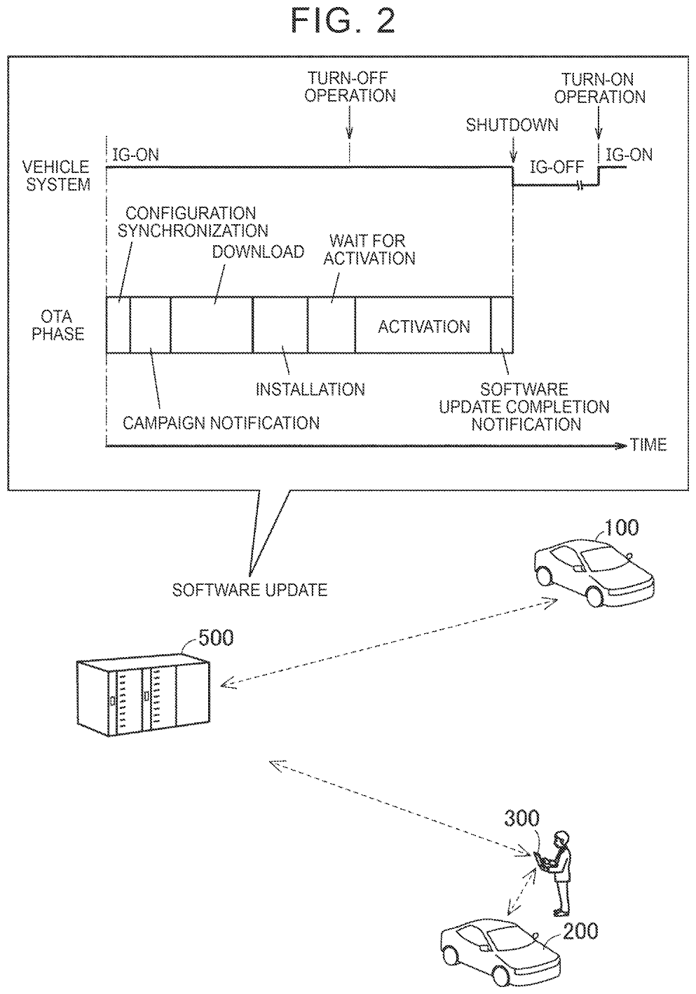

FIG. 2 illustrates an overview of a software update method using the OTA technology. Referring to FIG. 2 together with FIG. 1, a process related to software update is executed in accordance with a procedure including configuration synchronization, campaign notification and acceptance of application, download, installation, activation, and software update completion notification. The process described below is executed by the OTA center 500 and each vehicle (including the vehicles 100, 200) that receives software distribution from the OTA center 500. The number of vehicles that receive distribution from the OTA center 500 may be about 50, may be 100 or more and less than 1000, or may be 1000 or more. The following description is directed to a case where an ECU to be subjected to software update (hereinafter also referred to as “target ECU”) includes a dual-bank computer.

The vehicle in the IG-ON state repeats the configuration synchronization every preset time period. The vehicle in the IG-ON state also executes the configuration synchronization when it receives a request for configuration synchronization that is sent from the OTA center 500. The configuration synchronization process that is executed by the vehicle includes transmitting vehicle configuration information to the OTA center 500. The vehicle configuration information includes, for example, hardware information (information indicating product numbers of hardware, identifiers of the ECUs, etc.) and software information (information indicating product numbers of software etc.) of the individual ECUs in the vehicle.

When the OTA center 500 receives the vehicle configuration information from the vehicle, the OTA center 500 checks for any currently available campaign (software update). When there is any campaign that is applicable to the vehicle, the OTA center 500 transmits an acceptance request signal that requests the user of the vehicle to accept download of new software (updated version of software) related to that campaign. The acceptance request signal includes information on the campaign (campaign information). The campaign information may include, for example, at least one of the following pieces of information: campaign attribute information (information indicating the purpose of the software update, the function(s) of the vehicle that can be affected by the update, etc.), a list of vehicles targeted for the campaign, information on ECUs targeted for the campaign (e.g., software information before and after the update), and information on notifications to be sent to the user before and after the update. The notified campaign may be a newly available campaign or may be a campaign that was not applied previously. Hereinafter, transmission of the acceptance request signal will also be referred to as “campaign notification”.

When the vehicle receives the campaign notification (acceptance request signal), the vehicle requests the user to enter whether to accept to apply the campaign. For example, the vehicle displays a message such as “New software is available. Do you want to apply this software to this vehicle?” on the HMI (HMI device 170, 270 or user terminal 300, 400) to request the user to enter an input indicating either “accept” or “decline”. When the user enters an input indicating “accept”, the vehicle executes a process related to download described below. When the user enters an input indicating “decline”, the vehicle does not execute the process related to download. In this case, the OTA center 500 terminates the process related to software update without proceeding to a download phase.

In the present embodiment, the OTA center 500 and the update master of the vehicle (e.g., the OTA master 110 or the ECU 210) execute the process related to download in accordance with the following procedure.

The update master of the vehicle requests a distribution package including the new software from the OTA center 500. The update master downloads (receives and saves) the distribution package from the OTA center 500. The distribution package may include, in addition to the new software (e.g., a set of update data for each of the ECUs targeted for the campaign), package attribute information (information indicating the update category, the number of pieces of update data in the distribution package, the order of installation in the ECUs, etc.), and update data attribute information (an identifier of a target ECU, verification data for verifying the validity of the update data, etc.). A plurality of target ECUs may be set in the vehicles 100, 200.

The distribution package is saved in a storage device of the update master (e.g., the memory 112 or 212) through the process related to download described above. After the download is completed, the update master verifies the authenticity of the downloaded distribution package. When the verification result is “normal”, the update master notifies the OTA center 500 about the software update status (completion of the download). This notification means that the download was successful.

After the successful download, the vehicle executes installation. The update master requests at least one target ECU (e.g., the ECU 121 or 221) to output the state of the target ECU and a diagnostic trouble code (DTC). The update master determines for each target ECU whether the target ECU can execute installation based on the state of the target ECU and the DTC. By displaying the predetermined message on the HMI, the update master requests the user to enter an input indicating either “accept” or “decline”. When the user enters an input indicating “accept”, the update master transfers the new software (update data) to the target ECU that can execute installation. When the target ECU receives the update data, the target ECU installs the received update data (writes the received update data to a non-volatile memory). When the user enters an input indicating “decline”, the update master cancels the process related to software update without executing the installation.

When the transfer of the update data from the update master to the target ECU is completed, the target ECU transmits a transfer completion notification to the update master. When the update master receives the transfer completion notification, the update master requests the target ECU to execute integrity verification. In response to this request, the target ECU executes verification by using integrity verification data (verification data), and transmits the verification result to the update master. The update master saves the verification result (whether the installation was completed, failed, or was cancelled) from each target ECU. When the integrity verification is completed by all the target ECUs and the verification results from all the target ECUs are “normal”, the update master notifies the OTA center 500 about the software update status (completion of the installation). This notification means that the installation was successful.

When the installation is successfully executed in succession to the download, the vehicle waits for activation. When the start switch (e.g., the start switch 150 or 250) of the vehicle is subsequently turned OFF, the update master displays a predetermined message on the HMI to request the user to enter an input indicating either “accept” or “decline”. When the user enters an input indicating “accept”, the update master executes activation (activation of the installed software). In the case where the update master fails to activate the installed software, the update master requests the OTA center 500 to rollback the software. In response to the rollback request from the vehicle, the OTA center 500 distributes rollback software to the vehicle. Thus, the update master can restore (rollback) the software that was not successively activated to its original version by using the rollback software. When the user enters an input indicating “decline”, the update master cancels the process related to software update without executing the activation, and the vehicle system is shut down.

When the update master has successfully activated the installed software, the update master displays the result of the software update on the HMI. The update master notifies the OTA center 500 about the software update status (completion of the software update). This notification means that the OTA software update was successful. In response to this notification, the control system for the vehicle is shut down, and the vehicle system is switched to IG-OFF. When the start switch of the vehicle is subsequently turned ON, the vehicle system is switched to IG-ON. Thus, the update program (new version of the software) is started on the target ECU. The software to be updated is not limited to a control program for a drive assist system such as the autonomous driving control program described above, and may be any software.

In a case where the target ECU includes a single-bank computer when the distribution package (software) is downloaded and the software of the target ECU is updated, it is difficult to install update data (update software) during execution of current software because an area where the current software is stored and an area where the update software is stored are the same. In the present embodiment, when the target ECU includes both the single-bank computer and the dual-bank computer, the processes before and after turning OFF the start switch 150, 250 are varied between the single-bank computer and the dual-bank computer, therefore software update is achieved appropriate and prompt.

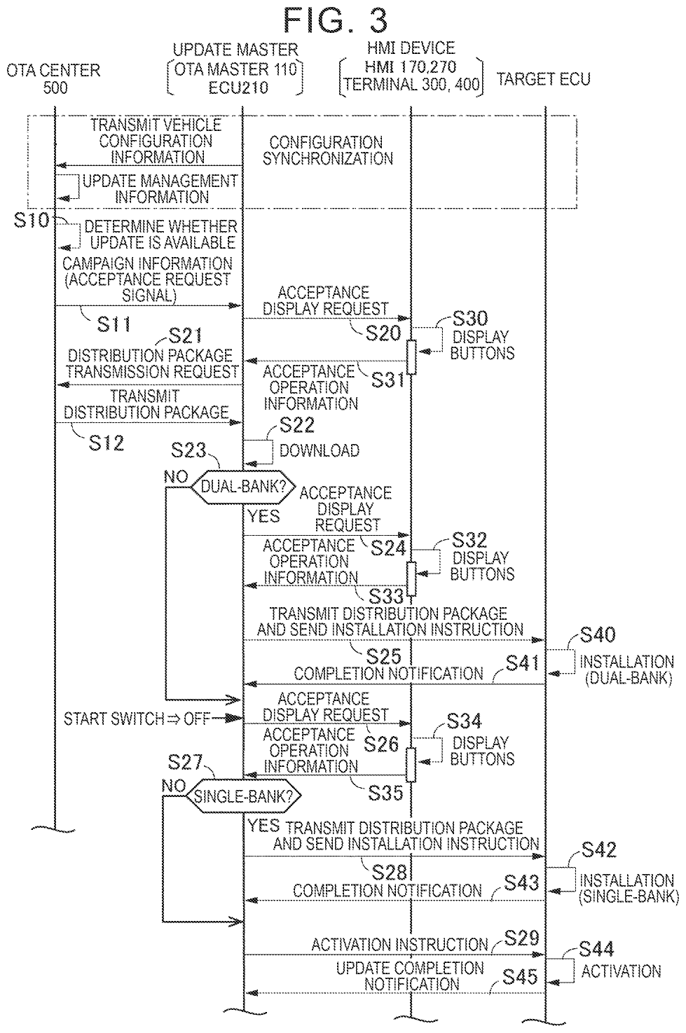

FIG. 3 schematically shows a part of a sequence that is executed in the software update system according to the present embodiment. This sequence is processed in the OTA center 500, the update master (OTA master 110 or ECU 210), the HMI (HMI device 170, 270 or user terminal 300, 400), and the target ECU. This process is implemented by one or more processors of each device reading and executing a program stored in one or more memories.

Referring to FIG. 3, when the configuration synchronization process is finished, the OTA center 500 determines in step S10 whether there is any campaign that is applicable. When there is any campaign that is applicable, the OTA center 500 transmits campaign information (acceptance request signal) to the update master (OTA master 110 or ECU 210) in step S11. When the update master receives the campaign information, the update master transmits an acceptance display request to the HMI (HMI device 170, 270 or user terminal 300, 400) (step S20). The acceptance display request is a request to cause the HMI to display whether to accept download of a distribution package (whether to accept to apply the campaign) and prompt the user to enter an input indicating whether to accept the software update process. The update master (OTA master 110 or ECU 210) is an example of the “control device” of the present disclosure.

When the HMI (HMI device 170, 270 or user terminal 300, 400) receives the acceptance display request, the HMI displays an operation unit (operation button) for accepting the software update (download of the distribution package) on the touch panel display (step S30).

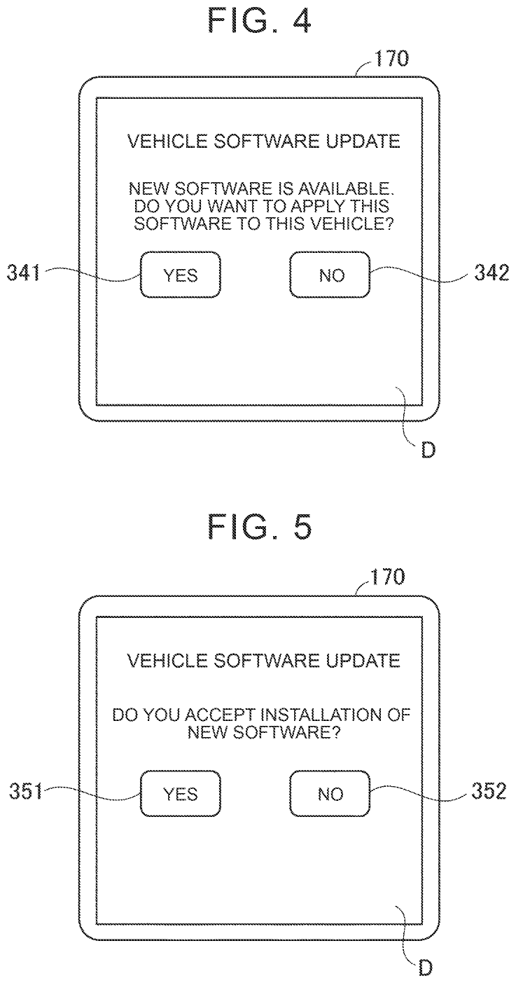

FIG. 4 shows an example of a display screen displayed on a touch panel display D of the HMI device 170. As shown in FIG. 4, a message indicating a vehicle software update process and the operation unit for accepting software download are displayed on the touch panel display D. In FIG. 4, a “YES” button 341 is an operation unit (operation button) for accepting download. When the user operates the “YES” button 341, download (software update process) of software (distribution package) is executed. When the user operates a “NO” button 342 displayed on the touch panel display D, the software download (software update process) is not executed, and the sequence is terminated. Although FIG. 4 shows the touch panel display D of the HMI device 170, a similar screen may be displayed on the HMI device 270 or the user terminal 300, 400 instead of the HMI device 170.

Referring to FIG. 3 again, when the user operates the “YES” button 341 on the touch panel display D to accept the download (software update process), the HMI transmits acceptance operation information to the update master (step S31). When the update master receives the acceptance operation information, the update master transmits a distribution package transmission request to the OTA center 500 (step S21). In response to the distribution package transmission request, the OTA center 500 transmits the distribution package (software) to the update master (step S12).

The update master saves the distribution package transmitted (distributed) from the OTA center 500 in the memory 112 or 212 to download the distribution package (step S22). When the download of the distribution package is completed, the update master verifies the authenticity of the distribution package, and then determines whether the ECU to be subjected to software update (target ECU) includes a dual-bank computer (memory) (step S23). When the target ECU includes a dual-bank computer, positive determination is made in step S23, and an acceptance display request is transmitted to the HMI in step S24. The acceptance display request is a request to cause the HMI to display whether to accept installation of the distribution package (software) and prompt the user to accept the installation.

When the HMI receives the acceptance display request, the HMI displays the operation unit (operation button) for accepting the software installation on the touch panel display (step S32).

FIG. 5 shows an example of the display screen displayed on the touch panel display D of the HMI device 170. As shown in FIG. 5, a message indicating the vehicle software update process and the operation unit for accepting the software installation are displayed on the touch panel display D. In FIG. 5, a “YES” button 351 is an operation unit (operation button) for accepting installation. Installation is executed when the user operates the “YES” button 351. When the user operates a “NO” button 352 displayed on the touch panel display D, the software update process is aborted, and the sequence is terminated. Although FIG. 5 shows the touch panel display D of the HMI device 170, a similar screen may be displayed on the HMI device 270 or the user terminal 300, 400 instead of the HMI device 170.

Referring to FIG. 3 again, when the user operates the “YES” button 351 on the touch panel display D to accept the installation, the HMI transmits acceptance operation information to the update master (step S33). When the update master receives the acceptance operation information (step S33), the update master transmits the distribution package (update software (update data)) to the dual-bank target ECU, and instructs the target ECU to install the update data (step S25). When the target ECU (dual-bank type) receives the update data, the target ECU installs the update software (writes the update software to the non-volatile memory) (step S40). When the installation of the update software is completed, the dual-bank target ECU transmits a completion notification to the update master (step S41). When the update master receives the completion notification from the target ECU, the update master waits for an operation to turn OFF the start switch 150, 250.

When the target ECU does not include a dual-bank computer, negative determination is made in S23, and the update master waits for an operation to turn OFF the start switch 150, 250 without, for example, transmitting the distribution package.

When the user turns OFF the start switch 150, 250 while the update master is waiting for the operation to turn OFF the start switch 150, 250, the update master transmits an acceptance display request to the HMI (step S26). The acceptance display request is a request to cause the HMI to display whether to accept activation of the software installed in the target ECU (whether to accept to apply the campaign) and prompt the user to make acceptance.

When the HMI receives the acceptance display request, the HMI displays the operation unit for accepting the software activation on the touch panel display (step S34).

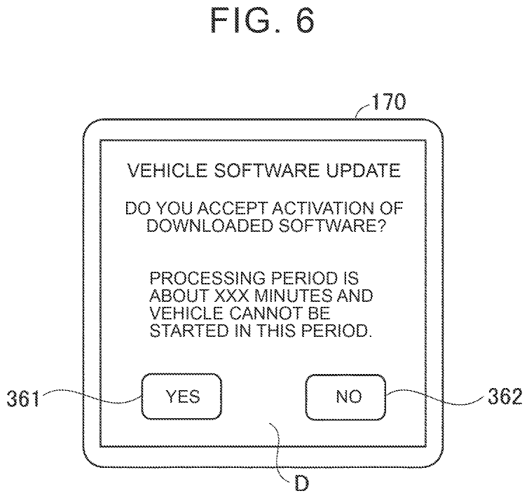

FIG. 6 shows an example of the display screen displayed on the touch panel display D of the HMI device 170. As shown in FIG. 6, a message indicating the vehicle software update process and the operation unit for accepting the software activation are displayed on the touch panel display D. In FIG. 6, a “YES” button 361 is an operation unit (operation button) for accepting activation. When the user operates the “YES” button 361, the activation of the software (software activation process) is accepted by the user, and the activation is executed. When the user operates a “NO” button 362 displayed on the touch panel display D, the software update process is aborted, and the sequence is terminated. Although FIG. 6 shows the touch panel display D of the HMI device 170, a similar screen may be displayed on the HMI device 270 or the user terminal 300, 400 instead of the HMI device 170.

Referring to FIG. 3 again, when the user operates the “YES” button 361 on the touch panel display D to accept the activation (the software update process), the HMI transmits acceptance operation information to the update master (step S35). When the update master receives the acceptance operation information, the update master determines in step S27 whether the target ECU includes a single-bank computer. When the target ECU includes a single-bank computer, positive determination is made in step S27, and the distribution package is transmitted to the single-bank target ECU and an instruction to install the update data is issued in S28. When the target ECU (single-bank type) receives the update data, the target ECU installs the update software (writes the update software to the non-volatile memory) (step S42). When the installation of the update software is completed, the single-bank target ECU transmits a completion notification to the update master (step S43).

When the target ECU does not include a single-bank computer and negative determination is made in step S27 or when a notification of completion of installation of the update software (step S43) is received from the single-bank target ECU, the update master transmits an activation instruction to the target ECU (step S29). When the target ECU receives the activation instruction from the update master, the target ECU activates the installed update software (step S44). When the activation is successfully executed, the target ECU transmits an update completion notification to the update master (step S45).

With the present embodiment, the vehicle 100, 200 including the target ECU (ECU 121, 122, 221, 222) includes the start switch 150, 250 to be turned ON to start the control system of the vehicle 100, 200, and the update master (OTA master 110 or ECU 210) configured to control the process for updating software distributed from the OTA center 500. When the target ECU includes both the single-bank computer and the dual-bank computer, the update master executes, for the target ECU including the single-bank computer, download of the software distributed from the OTA center 500 (step S22), and then installation of the downloaded software in the target ECU (step S42) and activation of the installed software (step S44) after the start switch 150, 250 is turned OFF. For the target ECU including the dual-bank computer, the update master executes download of the software distributed from the OTA center 500 (step S22) and installation of the downloaded software in the target ECU (step S40), and then activation of the installed software (step S44) after the start switch 150, 250 is turned OFF.

When the start switch 150, 250 is turned OFF, the control system of the vehicle 100, 200 can be stopped. Thus, the software can be installed in the single-bank computer. Therefore, the target ECU including the single-bank computer executes installation and activation after the start switch 150, 250 is turned OFF. The target ECU including the dual-bank computer installs the software before the start switch 150, 250 is turned OFF, and activates the software after the start switch 150, 250 is turned OFF. Thus, the software update can be executed appropriately and promptly depending on the type of each target ECU.

With the present embodiment, the update master requests acceptance to execute the activation when the start switch 150, 250 is turned OFF (step S26). In a case where the target ECU includes the single-bank computer when the user accepts the activation, the software is installed (step S42) and activated (step S44). In a case where the target ECU includes the dual-bank computer, the installed software is activated (step S44). Therefore, in the single-bank ECU, the installation and activation are executed by accepting the activation (step S35). Thus, even in the case where the target ECU includes both the single-bank computer and the dual-bank computer, a common acceptance request can be displayed on the HMI after the start switch is turned OFF.

The vehicle may be an electrified vehicle (xEV) other than a BEV. The vehicle may be a plug-in hybrid electric vehicle (PHEV) or a hybrid electric vehicle (HEV) including an internal combustion engine (e.g., a gasoline engine, a biofuel engine, or a hydrogen engine). The vehicle is not limited to a four-wheeled passenger car, and may be a bus or a truck, or may be a three-wheeled xEV. The vehicle may have a flight function. The vehicle may be a Mobility-as-a-Service (MaaS) vehicle. The vehicle may be a multi-purpose vehicle to be customized depending on the purpose of use of the user. The vehicle may be a traveling shop vehicle, a robotaxi, an automated guided vehicle (AGV), or an agricultural machine. The vehicle may be a small-sized unmanned or single-seater BEV (e.g., a last-mile BEV, an electric wheelchair, or an electric skateboard).

In the above embodiment, the installation acceptance request is displayed in a case where the target ECU is the dual-bank ECU, (steps S24 and S32), but the acceptance request may be omitted when the operation of the target ECU is not restricted along with the installation.

In the present embodiment, determination is made as to whether the target ECU includes the single-bank computer (step S27) after the start switch 150, 250 is turned OFF. Determination may be made as to whether the target ECU includes the single-bank computer before the start switch 150, 250 is turned OFF. When positive determination is made in step S27 in this case, the update master makes transition to wait for an operation to turn OFF the start switch 150, 250. When the start switch 150, 250 is turned OFF, the update master transmits the acceptance display request to the HMI (step S26). When the update master receives the acceptance operation information (step S35), the update master transmits the distribution package to the single-bank target ECU, and instructs the target ECU to install the update data (step S28). The subsequent process is the same as that in FIG. 3. When negative determination is made in step S27, the update master executes the same process as that described above, and proceeds to step S29 when the acceptance operation information is received in step S35. When the update master executes step S27 before the start switch 150, 250 is turned OFF, it is possible to shorten the period from the time when the update master receives the acceptance operation information in step S35 to the time when the activation is completed.

In the present embodiment, the update master includes one processor and one memory, but may include a plurality of processors and a plurality of memories. In the present embodiment, the software update for the target ECU different from the update master has been described, but the software of the update master itself may be updated.

The embodiment disclosed herein should be construed as illustrative in all respects and not restrictive. The scope of the present disclosure is shown by the claims rather than by the above description of the embodiment and is intended to include all modifications within the meaning and scope equivalent to the claims.

What is claimed is:

1. A vehicle including an electronic control unit configured to execute software update by using software distributed from a server, the vehicle comprising:
a start switch configured to start a control system of the vehicle when the start switch is turned ON, and to stop the control system of the vehicle when the start switch is turned OFF; and
a control device configured to
control a process for the software update,
request acceptance to execute activation after the start switch is turned OFF,
when the electronic control unit is a single-bank computer, download the software distributed from the server, and then instruct the electronic control unit to install the downloaded software in the electronic control unit and activate the installed software after a user accepts to execute the activation, and
when the electronic control unit is a dual-bank computer, download the software distributed from the server, instruct the electronic control unit to install the downloaded software in the electronic control unit, and then instruct the electronic control unit to activate the installed software after the user accepts to execute the activation.

2. The vehicle according to claim 1, wherein the electronic control unit is an electronic control unit configured to execute traveling control on the vehicle.

3. A software update method for executing software update for an in-vehicle electronic control unit by using software distributed from a server, the software update method comprising:
requesting acceptance to execute activation when a start switch is turned OFF, the start switch being configured to start a control system of a vehicle when the start switch is turned ON and to stop the control system of the vehicle when the start switch is turned OFF;
when the in-vehicle electronic control unit is a single-bank computer, downloading the software distributed from the server, and then instructing the in-vehicle electronic control unit to install the downloaded software in the in-vehicle electronic control unit and activate the installed software after a user accepts to execute the activation; and
when the in-vehicle electronic control unit is a dual-bank computer, downloading the software distributed from the server, instructing the in-vehicle electronic control unit to install the downloaded software in the in-vehicle electronic control unit, and then instructing the in-vehicle electronic control unit to activate the installed software after the user accepts to execute the activation.

4. A non-transitory storage medium configured to store a program that causes a control device to execute the software update method according to claim 3.

5. A vehicle including an electronic control unit configured to execute software update from pre-update software to post-update software by using data distributed from a server, the vehicle comprising:
a switch configured to stop a control system of the vehicle when the switch is turned OFF; and
a control device configured to
control a process for the software update,
request acceptance to execute activation after the switch is turned OFF,
determine whether the electronic control unit is a single-bank computer or a dual-bank computer,
when the electronic control unit is the single-bank computer and the control device receives the acceptance to execute the activation, instruct the electronic control unit to install the post-update software in the electronic control unit and activate the post-update software, and
when the electronic control unit is the dual-bank computer and the control device receives the acceptance to execute the activation, instruct the electronic control unit to activate the post-update software.
